(19) United States
(12) Patent Application Publication
(10) Pub. No.: US 2009/0099952 A1
(43) Pub. Date: Apr. 16, 2009

(54) Trading System for Handling an Order Matrix

(76) Inventor: Lars Wahlberg, Taby (SE)

Correspondence Address: COATS & BENNETT, PLLC, 1400 Crescent Green, Suite 300, Cary, NC, 27518, US

(21) Appl. No.: 11/871,231

(22) Filed: Oct. 12, 2007

(51) Int. Cl. G06Q 40/00

(52) U.S. Cl. 705/37; 705/35; 705/1

(57) ABSTRACT

An exchange system and a method for trading orders on an exchange market and a related broker workstation. One or more user defined order matrixes allows a user to design a trading strategy by manually, or by means of algorithms using current and/or historical market data, determine trading parameters such as part order size, price level, time delay between consecutive part orders. An order having a total volume and at least one such order matrix associated therewith is received from a market participant. The order matrix specifies predetermined portions of the order's total volume. A first portion of the order's total volume is determined in accordance with the order matrix and information is sent to display the that portion to the market. A next portion of the order's total volume is generated in accordance with the order matrix and information is then sent to display that portion to the market.

### BACKGROUND OF THE INVENTION

The present invention relates to an exchange system and/or to a broker workstation for transmitting orders to the exchange system, and to a method for trading orders on an exchange market.

Investors or market participants of an exchange trading market have to trade orders of different sizes including small and large orders. In any case, the market participants, whether they are buyers or sellers, wish to obtain the best price level when executing their orders. However, the risk to rapidly influence conditions and prices on the market when placing an order having a large volume or size is particularly high. As soon as a market participant's order having a large size is displayed on the exchange market, other market participants become aware of the order and try to benefit from the situation, thereby influencing prices on the market. As an example, if a market participant or an investing institute wishes to buy a big amount of shares, the price per share is more likely to increase when other market participants become informed of the size of the order. As a result, the market participant or investing institute has to pay more than what was expected when analyzing the price level on the market before sending the order.

To overcome this problem, a market participant has, as a first alternative, the possibility to send a first fraction of the total size of the order to an exchange system, which system sends a signal or information to trading terminals for display of the first fraction to other market participants. Then, the market participant waits until the first fraction has been traded to send another fraction of the total volume of the order to the exchange system. In this manner, the real total size of the order is not exposed at once to the market. However, this method is not very efficient nor convenient for the market participant since he or she has to wait until a fraction of the order has been traded before sending the next fraction.

In a second alternative, which is more convenient for a market participant than the first alternative, the market participant has the possibility to send an order to the exchange market with the option of hiding the total size (or volume) of the order. This type of order is called an “iceberg order” since the total size of the order is hidden from other participants or market participants of the market. The exchange system then divides the total size of the order in a number of portions or fractions each having the same size or volume. The exchange system sends information to trading terminals for display of a first portion of the order and waits until the first portion has been traded to send information to the trading terminals for display of a next portion having the same size as the first portion. Just as the “tip of the iceberg” is the only visible portion of a huge mass of ice. Using an “iceberg order”, a whole order may be executed before other market participants notice that the order had a large volume.

However, a drawback of this technique is that the display of consecutive small orders having the same size or volume easily can be tracked by other market participants by means of programs installed on their trading terminals or work stations. The programs may easily be implemented for identifying repetitive orders having equal size. Upon positive result from the programs installed on his/her workstation, although the total size of the order is not known, a market participant may react and thereby influence prices on the market.

In another alternative, for trading orders having a hidden total volume on an automated exchange market, document U.S. Pat. No. 6,983,260 discloses an automated exchange system, which divides the total volume of the order in a series of fractions having random sizes. In this manner, it is more difficult for other market participants to track that a market participant's order having a large size is currently traded on the market. However, the degree of flexibility and control desired by a market participant when using this method may not be fulfilled.

Although a number of methods exist to trade an order having a large total size on an exchange market, a preferred method would be a method which is convenient, efficient and flexible for a market participant to use and at the same time minimizes the possibilities for other market participants to trace the order.

In addition, such a preferred method would consider the problem of managing memory capacity and processing capacity at the exchange system, which is particularly important for processing orders having large volumes.

Thus, there is a need for providing improved methods and systems for trading orders on an exchange market, which methods and systems would overcome some of these problems.

### SUMMARY OF THE INVENTION

The present invention provides a method and systems having means to increase flexibility when trading orders having a large volume on an exchange trading market. In addition, the present invention provides a method and systems, which are convenient for a market participant and comprising means to send orders having a large volume minimizing the possibility for other market participants to track or trace the order.

As used herein, the term “market participant” refers to any person or firm with the ability to trade securities; examples of market participants include broker dealers, institutions, hedge funds, statistical arbitrage and other proprietary operations, and private investors.

The present system and method are particularly useful for trading securities such as stocks, shares, bonds, futures, options and other financial instruments. Moreover, raw materials such as metals may also be traded in the system according to the present invention.

The present invention in particular relates to a trading system for handling a user defined order matrix, which allows a user to customize or design a trading strategy by manually, or by means of algorithms using current and/or historical market data, determining trading parameters such a part order size, price level, time delay between consecutive part orders, buy or sell, time validity, etc.

Hence, according to a first aspect of the present invention, a method for trading orders on an automated exchange market is provided. The method includes the step of receiving an order having a total volume and at least one user defined order matrix associated with the order from a market participant. The user defined order matrix specifies predetermined portions or part orders of the total volume of the order. The method includes also the step of generating a first portion of the total volume of the order in accordance with the user defined order matrix, and the step of sending information to display the first portion to the market. Further, the method includes the step of generating a next portion of the total volume of the order in accordance with the user defined order matrix, and the step of sending information to display the next portion to the market.

According to a second aspect of the present invention, an exchange system for trading orders on an exchange market is provided. The exchange system includes a data processor configured to receive an order having a total volume and at least one user defined order matrix associated with the order from a market participant connected to the system via a workstation. The user defined order matrix specifies predetermined portions or part orders of the total volume of the order. The data processor is also configured to generate a first portion of the total volume of the order in accordance with the user defined order matrix, and to send information to display the first portion to the market. Further, the data processor is configured to generate a next portion of the total volume of the order in accordance with the user defined order matrix, and to send information to display the next portion to the market.

According to a third aspect of the present invention, an exchange system for trading orders on an exchange market is provided. The exchange system includes a receiving module adapted to receive an order having a total volume and at least one user defined order matrix associated with the order from a market participant connected to the system via a workstation. The user defined order matrix specifies predetermined portions of the total volume of the order. The exchange system includes also a generating module adapted to consecutively generate portions of the total volume of the order in accordance with the user defined order matrix, and a sending module adapted to send information to consecutively display the generated portions to the market. Further, the exchange system includes a data processor adapted to control the receiving module, the generating module and the sending module.

According to a fourth aspect of the present invention, a broker work station for transmitting orders to an automated exchange system is provided. The broker workstation is connectable to input devices allowing a user of the workstation to input order matrix data. The broker work station includes a generator adapted to generate an order matrix specifying portions of a total volume of an order based on the user defined order matrix data, and a transmitting module for transmitting the order and the order matrix associated with the order to the automated exchange system.

According to a fifth aspect of the present invention, a computer readable medium is provided. The computer readable medium has computer executable instructions for carrying out steps of the method as described above when run on a processing unit.

An advantage of one or more embodiments of the present invention is that the flexibility is increased since an investor or market participant transmits an order and a user defined order matrix associated with the order to an exchange system, in which order matrix the market participant has specified predetermined portions of the total volume of his or her order to be traded at each time. That is, the market participant, e.g., the user of the broker workstation, is able to define or customize the order matrix to cope with, for example, the current market situation. Other parameters apart from the volume of each portion may also be defined in the matrix, for example, price, time delay between the execution of one order until the next one in the matrix is displayed to the market, ask or bid order, time validity, etc.

The use of a user defined order matrix specially dedicated to a particular order offers flexibility to the market participant as he or she may, for instance, simulate the execution of his/her order before he/she sends the order to the exchange system. The order matrix provides also a general overview of the order, or in fact the collection of orders included in the order matrix, to the market participant.

Another advantage of one or more embodiments of the present invention is that the market participant may use the user defined order matrix as a tool to hide his/her orders from other market participants and possibly as a tool to establish a strategy with regard to the behaviour of other market participants. Accordingly, an order to sell a large volume of a certain security may be divided into smaller portions each including a fraction of the total volume, which portions can be selected by the seller when defining or customizing the order matrix.

According to an embodiment, each of the predetermined portions of the user defined order matrix corresponds to an integer of a predetermined trading post in terms of volume.

According to an embodiment, the exchange system sends information to display a portion of the order when receiving information that a preceding trade has been executed. Alternatively, the exchange system may schedule the display of consecutive portions in accordance with predetermined time delays specified in the order matrix. The exchange system may delay the display of a portion a predetermined period of time equal to the predetermined time delay from the execution of a preceding trade having a volume specified in the order matrix.

According to one embodiment of the present invention, the delay may, for example, be a delay determined by the exchange system according to an algorithm using current and/or historical data and/or randomly determined within user defined limits. Diverse combinations of time delays may be predetermined in the order matrix in order to freely customize the display of the portions of the order to the market. Thus, a market participant has several possibilities to adapt the order matrix to a particular order and to establish a strategy on how to display his/her order to the market.

The content of the user defined order matrix is not only limited to the size of the portions and the length of the delays determining when to display the portions to the market, but may also include price information corresponding to each of the predetermined portions. According to one embodiment of the present invention, the price may, for example, be a price determined by the exchange system according to an algorithm using current and/or historical data and/or randomly determined within user defined limits.

Accordingly, the user defined order matrix containing a number of part orders is treated as one single order by the exchange system and can thus be inserted, updated, cancelled or activated/suspended. This increases the efficiency and trading speed. For example, if a market participant or trader wants to update the price level of his or her outstanding orders, each order has to be updated. If, instead, an order matrix containing the orders was placed on the market, the updating can be performed on the order matrix, which saves time and increases the efficiency.

One or more embodiments of the present invention advantageously allow the exchange system receiving the order and the order matrix to improve the planning or scheduling of trading actions. The exchange system may for instance determine a data load for the market and schedule trading actions for the received order in accordance with the determined data load and the order matrix. Thus, the use of an order matrix facilitates the management of e.g., memory capacity and processing capacity at the exchange system.

Further features of, and advantages with, the present invention will become apparent when studying the following detailed disclosure, the drawings and the appended claims. Those skilled in the art will realize that different features of the present invention can be combined to create embodiments other than those described in the following.

### BRIEF DESCRIPTION OF THE DRAWINGS

FIG. 1 shows an exchange system for trading orders on an exchange market according to an embodiment of the present invention.

FIG. 2 shows a flow chart illustrating the steps of the method according to the present invention.

FIG. 3 shows an order matrix according to an embodiment of the present invention.

All the figures are schematic and generally only show parts, which are necessary in order to elucidate the invention, wherein other parts may be omitted or merely suggested.

### DETAILED DESCRIPTION OF THE INVENTION

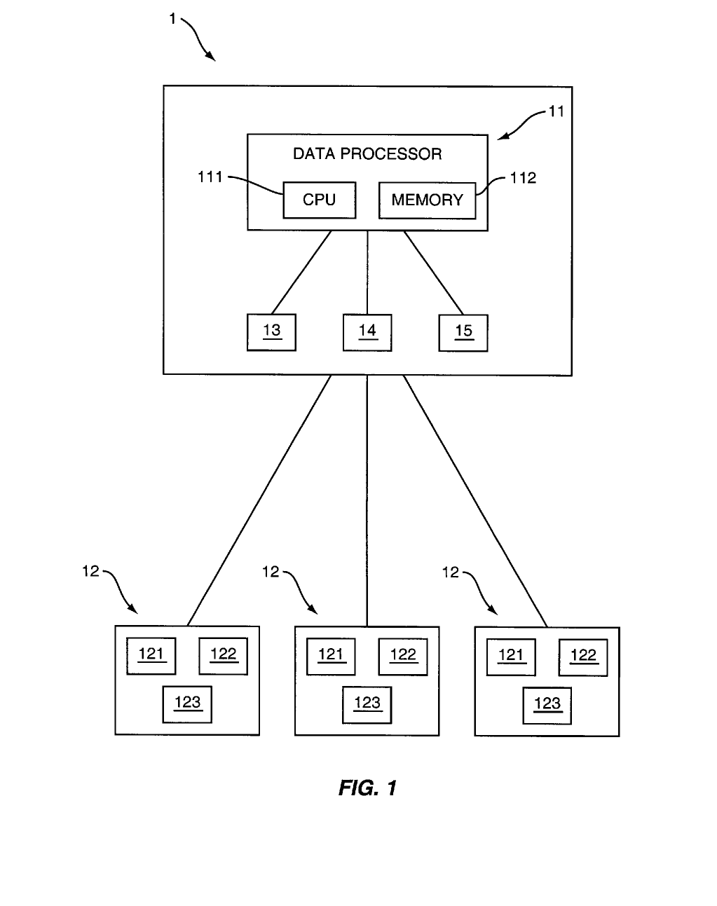

With reference to FIG. 1, a first aspect of the present invention will be described.

FIG. 1 shows an exchange system 1 for trading orders on an exchange market. The exchange system 1 comprises a data processor or central computer 11 connected to a plurality of workstations or trading terminals 12. The data processor 11 may comprise a processing unit 111 and a memory 112. The exchange system may also comprise a receiving module 13 adapted to receive an order and an order matrix associated with the order from a market participant connected to one of the workstations 12, a generating module 14 adapted to generate the received order in accordance with the order matrix, and a sending module 15 adapted to send information to the work stations 12 for displaying the order to other market participants. The receiving module 13, the generating module 14 and the sending module 15 are controlled by the data processor 11. Each workstation 12 is connectable to input devices, for example, a keyboard and/or a mouse, allowing a user of the station 12 to input instructions and commands, for example when defining or customizing an order matrix. Thus, the user may set portion sizes, prices, time delays, ask or bid (sell or buy), time validity upper and/or lower limits prices and/or time delays. The workstations 12 are configured to send data to and receive data from the exchange system 1.

According to an embodiment, the receiving module 13, the generating module 14 and the sending module 15 are optional since the data processor 11 may be configured to perform the steps and actions carried out by these modules.

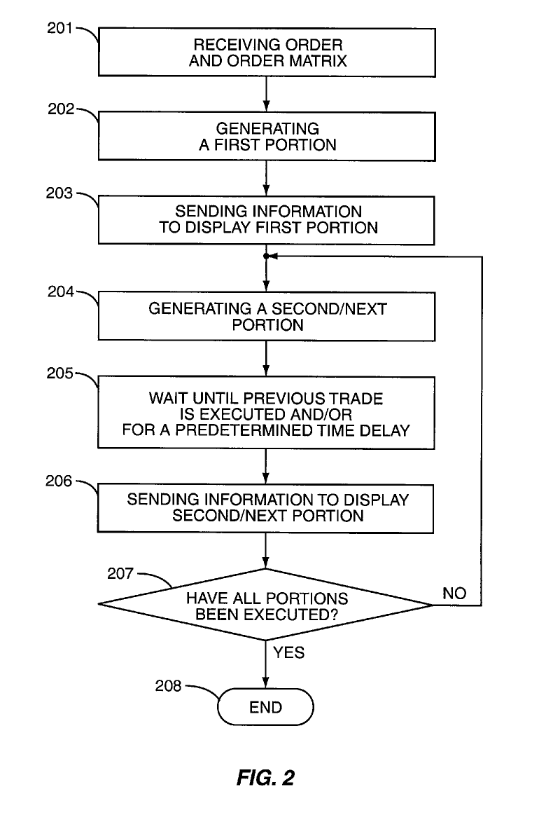

The data processor 11 of the exchange system 1 and the workstations 12 are designed to operate in accordance with the method described with reference to FIG. 2 in the following.

In a first step 201, the data processor 11 of the exchange system 1 receives, at the receiving module 13, an order and a user defined order matrix associated with the order from a market participant connected to the exchange system 1 via a work station 12. The user has defined the order matrix, which specifies how the market participant wishes that the exchange system 1 should handle the order. The use of such an order matrix is particularly advantageous when a market participant sends an order having a large total volume or size since the market participant can customize portion sizes, prices, time delays, ask or bid (sell or buy), time validity, upper and/or lower limits of prices and or time delays. The specific price and/or time delay used by the exchange system can be determined in a large number of ways. For example, it can be determined by the generating module 14 by means of an algorithm that uses current and/or historical market data and/or randomly within the predetermined user defined limits. Thereby, a strategy including price, volume, time delay between consecutive portions of the total order, ask or bid, time validity, etc. can be defined by the user.

The user defined order matrix indicates predetermined portions of the total volume of the order. The market participant or investor may prefer to create an order matrix with portions having different sizes or equal sizes. A workstation 12 comprises a generator 121 adapted to generate the order matrix specifying the portions of the total volume of the order based on the user input as defined above, and a transmitting module 122 for transmitting the order and the order matrix associated with the order to the exchange system 1.

According to an embodiment, each of the predetermined portions of the order matrix corresponds to an integer of a predetermined trading post in terms of volume.

Optionally, the work station 12 may comprise a simulating module 123 adapted to simulate, preferably faster than in real-time, the execution of the order in accordance with the order matrix before the market participant sends the order and the order matrix to the exchange system 1.

The user defined order matrix provides the market participant with a user-friendly overview of his/her order and enables adjustments of the content of the order matrix before he/she sends it to the exchange system 1.

Upon reception of an order and a user defined order matrix associated with the order, step 201, the exchange system 1 starts executing the order in accordance with the user defined order matrix, steps 202-208.

The exchange system 1, via a generating module 14, generates a first portion of the total volume of the order in accordance with the order matrix, step 202. Then, the exchange system 1 sends information via the sending module 15 to the workstations 12 to display the first portion (step 203). A second portion can then be generated by the generating module 14 of the exchange system 1 in accordance with the order matrix (step 204).

Then, as one alternative, when the exchange system receives information that a preceding trade has been executed (205), the exchange system 1 sends information via the sending module 15 to the work stations 12 to display the next portion (step 206). As another alternative, the exchange system may wait before sending information to display the next portion in accordance with a waiting time specified in the order matrix. The waiting time may be a time delay indicating the period of time the display of a portion is to be delayed from the execution of a preceding trade specified in the order matrix. The data processor 11 may select one of these alternatives in accordance with the content of the order matrix (step 205).

Then, the data processor 11 of the exchange system 1 repeats the steps of generating a next portion of the total volume of the order and sending information to display the next portion to the market in accordance with the order matrix until all portions specified in the order matrix have been displayed (207).

Once all the portions of the total volume of the order have been executed, the execution of the order is finished (208). A signal may be sent to the market participant to inform that his/her order has been completely processed.

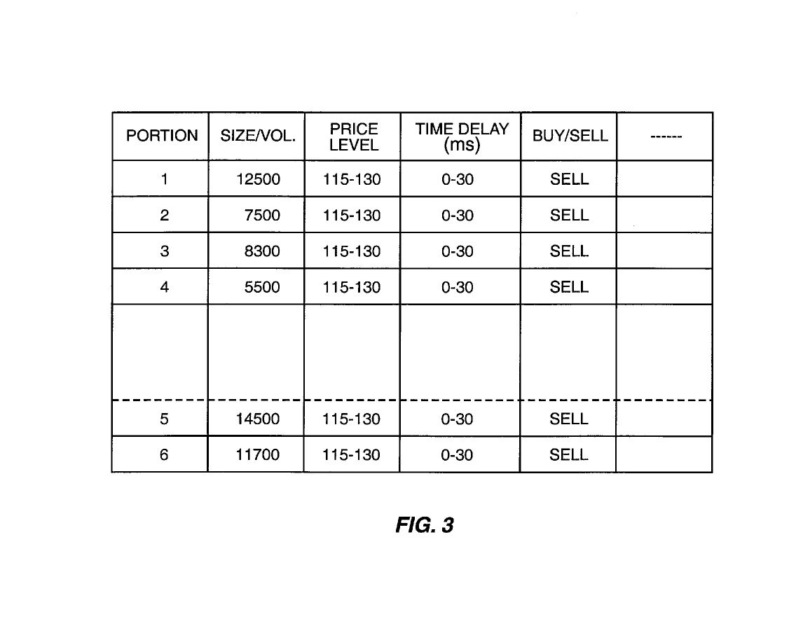

An example of an order matrix 3 created by a market participant is described with reference to FIG. 3. A user defined order matrix according to the present invention includes an arbitrary number of columns and rows. The illustrated example order matrix 3 includes an six columns in which a first column is used to sequence-number the different portions of the volume of the order, a second column indicates the size or volume of each of the portions, a third column specifies the price (which, may contain user defined limits), a fourth column indicates the time delay separating the execution of the different portions (i.e., the time delay between the end of a previous trade of a portion and the display of the portion, and which may contain user defined limits), a fifth column indicates ask or bid (sell or buy) and a sixth column indicates that the selection of number of columns is arbitrary, it may, for example, contain time validity.

In the following, specific examples will be discussed in illustrative purposes with reference to FIG. 3. In the example, shares in USD (US dollars) will be traded in the system according to the present invention. However, as indicated above, a large number of different securities may be traded in the system. Further, as the skilled person realizes, the use of USD is only one example of a currency in which a security may be traded.

In the example, a market participant wishes to trade an order having a total volume of 91700 shares. In this particular example, the market participant wishes to sell shares; however, the method of the present invention is equally applicable in a situation where a market participant wishes to buy shares or buy or sell any other type of security. The market participant, by means of e.g., the generator 121 of his/her workstation, has determined 10 portions or part orders of the total volume of the order, the sum of the 10 portions corresponding to the total volume of the order, price levels, time delays, and buy or sell.

The generating module 14 will generate a price based on user-defined parameter, for example, upper and lower limits. The price may be determined by means of an algorithm that uses current and/or historical market data, and/or randomly within the predetermined limits, or set manually by the user. For each portion or part order it is further determined time delay, buy/sell, time validity, etc. As has been described above, the user may, for example, determine these parameters manually, by means of algorithms using current and/or historical market data or randomly (in case of time delay). In this example, the user wants to sell shares and therefore enters sell in the column indicating buy/sell. However, as indicated in the third row, a buy order has been entered to confuse or bewilder the other market participants making it more difficult to trace or track the order. Thus, the user of the order matrix concept according to the present invention enables the user to design or customize a complete trading strategy.

For the first portion or part order, the user defined order matrix indicates that the volume is 12500 shares and that user has defined limits on the price, 115 as the lower limit and 130 as the upper limit. In one example, an algorithm of the generating module 14 is to enter a sell order with a price that is equal to the best buy price currently at the market plus a random value that is ±% of that price. The price must be within the user defined limits. The user has set a limit of 115-130 and at the market the best buy price is 115. The generating module 14 decides to put the sell price of 115+3 (random value), i.e., a price level of 118.

In another example with the same user defined limits, 115 as a lower limit and 130 as the upper limit, the algorithm of the generating module 14 is to enter a sell order with a price being equal to the average best buy price at the market during a defined period of time (e.g., 15 minutes), which period of time also may be set by the user, plus a random value that is ±% of that price. The price must be within the user defined limits. The user has set a limit of 115-130 and at the market the best buy price was 110 during 5 minutes, 120 for 5 minutes and 130 for 5 minutes. The average price of best buy price for the latest 15 minutes is therefore 120 ((110+120+130)/3). The generating module 14 decides to put the sell price of 120−2 (random value), i.e., a price level of 118.

When the exchange system 1 receives such an order matrix with the corresponding order at the receiving module 13, a first portion or order corresponding to 12500 shares is generated at the generating module 14, and information is sent by the sending module 15 to the workstations 12 to display the first portion or order to other market participants. A second portion having a volume of 7500 shares is then generated at the exchange system 1, and information is sent to the work stations 12 connected to the exchange system 1 with a time delay. As discussed above, there are a number of different ways to determine the time delay. In this specific example, the generating module 14 has generated a time delay using an algorithm that determines a delay a period of time that is equal to the average insert delay to the market in the current order book during a defined period of time (e.g., 10 sec) plus a random value that is ±% that average delay. The delay must be within the user-defined limits, which, in this specific case, has been set to 0-30 ms. At the market, 400 orders have been inserted during the latest 10 sec, giving an average delay between each order of 10000/400=25 ms. The generator 121 decides to use a delay for the next part order of 25+4 (random value)=29 ms. For the second portion, the order matrix indicates that the price is 118 USD per share and thus a time delay of 29 ms.

Then, a third portion having a volume of 8300 shares is generated at the exchange system 1, and information is sent to the work stations 12 connected to the system 1 25 ms from the execution of the trade of the second portion. In this case, the order is to buy 8300 shares. As discussed above, the user may place a buy order in the matrix in order to confuse the market, i.e., to make more difficult to see a pattern in the trade. If no value is attributed to a time delay in the order matrix, the exchange system 1 sends information to the work stations 12 when receiving information that the previous trade, in this case portion 3, has been executed.

The data processor 11 of the exchange system 1 then continues to handle the order in accordance with the order matrix and finally generates a tenth portion having a volume of 11700 shares. The exchange system then sends information to the workstations 12 to display the tenth portion to the market participants 20 ms from the execution of the trade of the ninth portion at a price of 118. As mentioned above and as the skilled person in the art easily realizes, the price and time delays indicated in the matrix can be determined in a number of ways, for example, manually, or by means of algorithms using current and/or historical market data, partly randomly within user defined limits. Further, it is also conceivable to determine different parameters of a single matrix by means of different ways and to determine a certain parameter partly by means of an algorithm using current and/or historical market data and partly by means of a random parameter. Thus, the user or market participant is able to customize or design a complete trading strategy.

Although the invention above has been described in connection with preferred embodiments of the invention, it will be evident for a person skilled in the art that several modifications are conceivable without departing from the scope of the invention as defined by the following claims.

What is claimed is:

1. Method for trading orders on an automated exchange market comprising the steps of:
receiving an order having a total volume and at least one user defined order matrix associated with said order from a market participant, wherein said at least one user defined order matrix specifies predetermined portions of said total volume of said order;
generating a first portion of said total volume of said order in accordance with said order matrix;
sending information to display said first portion to said market;
generating a next portion of said total volume of said order in accordance with said order matrix; and
sending information to display said next portion to said market.

2. The method according to claim 1 wherein the step of sending information to display a next portion is performed when receiving information that a preceding trade has been executed.

3. The method according to claim 1 further comprising:
repeating the steps of generating a next portion and sending information to display said next portion until all portions specified in said order matrix have been displayed.

4. The method according to claim 1 wherein each of said predetermined portions of said order matrix corresponds to an integer of a predetermined trading post in terms of volume.

5. The method according to claim 1 further comprising the step of scheduling the steps of sending information to display consecutive portions in accordance with predetermined time delays specified in said order matrix.

6. The method according to claim 5 wherein at least one of said price levels and said time delays are determined by a method selected from the group consisting of manual determining, random determining within user defined upper and lower limits, determining by an algorithm based on current market data, and determining by an algorithm based on historical market data.

7. The method according to claim 1 wherein said order matrix further includes predetermined price information corresponding to each of said predetermined portions.

8. An exchange system for trading orders on an exchange market comprising a data processor configured to:
receive an order having a total volume and at least one user defined order matrix associated with said order from a market participant connected to said system via a work station, wherein said at least one user defined order matrix specifies predetermined portions of said total volume of said order;
generate a first portion of said total volume of said order in accordance with said order matrix;
send information to display said first portion to said market;
generate a next portion of said total volume of said order in accordance with said order matrix; and
send information to display said next portion to said market.

9. The system according to claim 8 wherein said data processor is further configured to send information to display a next portion of said total volume when receiving information that a preceding trade has been executed.

10. The system according to claim 8 wherein each of said predetermined portions of said order matrix corresponds to an integer of a predetermined trading post in terms of volume.

11. The system according to claim 8 wherein said data processor is further configured to schedule the display of said predetermined portions in accordance with predetermined time delays specified in said order matrix.

12. The system according to claim 11 wherein at least one of said price levels and said time delays are determined by a method selected from the group consisting of manual determining, random determining within user defined upper and lower limits, determining by an algorithm based on current market data, and determining by an algorithm based on historical market data.

13. The system according to claim 8 wherein said order matrix further includes price information for each of said predetermined portions.

14. An exchange system for trading orders on an exchange market comprising:
a receiving module adapted to receive an order having a total volume and at least one user defined order matrix associated with said order from a market participant connected to said system via a work station, wherein said at least one user defined order matrix specifies predetermined portions of said total volume of said order;
a generating module adapted to consecutively generate portions of said total volume of said order in accordance with said order matrix;
a sending module adapted to send information to consecutively display to said market the generated portions; and
a data processor adapted to control said receiving module, said generating module and said sending module.

15. The system according to claim 14 wherein said sending module sends information to display a portion of said total volume when said data processor has received information that a preceding trade has been executed.

16. The system according to claim 14 wherein each of said predetermined portions of said order matrix corresponds to an integer of a predetermined trading post in terms of volume.

17. The system according to claim 14 wherein said data processor controls said sending module in accordance with predetermined time delays specified in said order matrix.

18. The system according to claim 17 wherein at least one of said price levels and said time delays are determined by a method selected from the group consisting of manual determining, random determining within user defined upper and lower limits, determining by an algorithm based on current market data, and determining by an algorithm based on historical market data.

19. The system according to claim 14 wherein said order matrix further includes price information for each of said predetermined portions.

20. A broker work station for transmitting orders to an automated exchange system, said work station being connectable to input devices allowing a user of the workstation to input order matrix data, said work station comprising:
a generator adapted to generate an order matrix specifying portions of a total volume of an order based on said user defined order matrix data; and
a transmitting module for transmitting said order and said order matrix associated with said order to said automated exchange system.

21. The work station according to claim 20 wherein each of said predetermined portions of said order matrix corresponds to an integer of a predetermined trading post in terms of volume.

22. The work station according to claim 20 wherein said generator is further adapted to determine time delays for scheduling the display of said portions of said total volume on said trading exchange market, which time delays are included in said order matrix, wherein said time delays corresponds to periods of time for delaying a display of a portion on said trading exchange market from the execution of a preceding trade having a volume specified in said order matrix.

23. The work station according to claim 22 wherein said generator is adapted to perform at least one of:
randomly determine at least one of said price levels and said time delays within user defined upper and lower limits;
algorithmically determine at least one of said price levels and said time delays based on at least one of current market data and historical market data.

24. The work station according to claim 20 wherein said generator is further adapted to determine price information associated with each of said predetermined portions, which price information is included in said order matrix.

25. A computer readable medium having computer executable instructions for causing a processing unit to respond to the receipt of an order from a market participant having a total volume and at least one user defined order matrix associated therewith, said at least one user defined order matrix specifying predetermined portions of said total volume of said order, by:
generating a first portion of said total volume of said order in accordance with said order matrix;
sending information to display said first portion to said market;
generating a next portion of said total volume of said order in accordance with said order matrix; and
sending information to display said next portion to said market.
